(19) United States
(12) Patent Application Publication
(10) Pub. No.: US 2019/0112120 A1
(43) Pub. Date: Apr. 18, 2019

(54) Reusable Inflated Article

(71) Applicant: Eventide Inc., Little Ferry, NJ (US)

(72) Inventor: Richard C. Factor, Little Ferry, NJ (US)

(73) Assignee: Eventide Inc., Little Ferry, NJ (US)

(21) Appl. No.: 16/161,898

(22) Filed: Oct. 16, 2018

Related U.S. Application Data
(60) Provisional application No. 62/573,215, filed on Oct. 17, 2017.

(51) Int. Cl. B65D 81/36; A01K 23/00; B65D 81/05

(52) U.S. Cl. CPC B65D 81/36; B65D 81/052; A01K 23/005

(57) ABSTRACT

An inflatable cushion that is reusable, in particular as a doggy waste bag. One version of the inflatable cushion, air cushion or packaging cell has a folded edge and three sealed edges. One of the three sealed edges, or area adjacent thereto, has a weakened area that is capable of withstanding the pressure of gas from the packaging cell and the pressures involved in protecting an item being shipped, but is also capable of being torn by hand resulting in deflation of the inflatable cushion, air cushion or packaging cell.

### CROSS-REFERENCE TO RELATED APPLICATIONS

The present application claims the benefit of the filing date of U.S. Provisional Patent Application No. 62/573,215 filed Oct. 17, 2017, the disclosure of which is heereby incorporated herein by reference.

### BACKGROUND OF THE INVENTION

The present invention relates to inflated articles, and more particularly, to inflated cushions for packaging reused as a bag to dispose dog waste.

According to recent statistics, roughly 44% of Americans own a dog. Many devices and products have been developed for attending to dog waste, also known as “poop” or other such synonyms. However, despite the various contraptions and devices, most rely on the use of a simple plastic bag to collect poop.

While not all Americans own a dog, a much larger percentage have received a package delivery. Typically a package is filled with the packed object, but surrounding it is usually a cushioning material to protect the object and absorb any impact experienced by the object during shipping. Well known cushioning material includes, bubble wrap or packing peanuts. Both are generally made of some sort of plastic, polystyrene or other known material. On occasion, a biodegradable material is used.

One type of popular packaging material, which comes in a variety of forms, is an inflated cushion, pillow or air filled plastic cell. Their function is virtually the same as bubble wrap, packing peanuts and other conventional packing material. However, fewer of them are needed due to the larger nature of their cells and are advantageous to the shipper because they can be inflated onsite immediately prior to use, which cuts down on storage and shipping costs associated with such material.

The recipient of a package that utilizes an inflatable cushion is charged with the task of disposal of the inflatable cushion. It is up to the recipient to either re-use the inflatable cushion in another package, or dispose of them, typically by puncturing each cell, and disposing or recycling the material. However, the recipient often does not have the amount of shipments necessary to reuse all inflatable cushions received. Puncturing each cell for disposal amounts to a vast amount of waste because recycling such inflatable cushions is often not readily available to the typical recipient.

Therefore, in a consumer household (such as one of the 44% that has a dog), there exists a need to reuse the inflatable cushions in a manner to avoid excess waste. More particularly, in households with dogs, such inflatable cushions can be repurposed or reused as a dog waste bag.

### BRIEF SUMMARY OF THE INVENTION

The needs of reusing inflatable cushions or air cells meant for protecting packaged items during shipping are met through the present invention, which in one aspect provides a process for deflating cushions or air cells and repurposing them to be used as a doggy waste bag.

In another aspect of the present invention, the process by which a cushion or air cell is deflated for use in connection with a doggy waste bag is described. In another aspect of the present invention, the reusable cushion or air cell has a seam that is part of the film or plastic capable of withstanding the air pressure of the inflation process and strong enough to resist the pressure of the payload in the shipped package, but at the same time, the film or plastic is weak enough on a predefined seam or a section in order to be separated by pulling on it by hand without any tools or unusual physical strength and allow for deflation.

In yet another aspect of the present invention, the manner of making a cushion or air cell that can be easily deflated by hand is described. Such processes include use of lasers, mechanical weakening of the plastic or film, or directional polymerization of the plastic or film. In each a weakened area or seam is created that enables the plastic or film to withstand air pressures of the gas or air used for inflation and the pressures associated with protecting items during shipment, but at the same time, can be easily torn or punctured to deflate the air cell or cushion.

### BRIEF DESCRIPTION OF THE DRAWINGS

FIG. 1 is a picture of conventional film or plastic material used in connection with inflatable air cells or cushions for packaging material.

FIG. 2(a) is a conventional doggy waste bag.

FIG. 2(b) is a conventional film or plastic material used in connection with inflatable air cells or cushions for packaging material.

FIG. 3 is a picture of using a common tool, e.g., scissors, to implement and remove the flattened, gas-permeable end of one of the air cells or cushions, to create a plastic bag usable for the same function as a conventional doggy waste bag.

FIG. 4 is a picture of the film or plastic material formerly used as an inflatable air cells or cushion for packaging material in a deflated state and being used as a doggy waste bag.

FIG. 5 is a picture of a plurality of air cells or cushions that are connected at the corner portions of a seam and have a secondary breakaway seam between the attached corner portions.

### DETAILED DESCRIPTION

The inflatable cushions used by the masses are made using various forms of films, plastic films or other such material. Materials suitable for inflatable cushions are well known in the industry. The films may be conveyed through an apparatus so that the film is folded, inflated and sealed in order to form the inflatable cushion. Such process may happen in a factory or in warehouse prior to use in a shipment or package. Many types of films have been described in the art that are useful in connection with the present invention. There are also various types of devices known in the art that can be utilized in folding, inflating and sealing air within the film in order to create the inflatable cushions described herein.

The inflatable cushions are generally in a square or rectangular shape, but other shapes can be used for purposes of the present invention. In one embodiment of the present invention, the inflatable cushions generally have about ¼ liter to about ¾ liter capacity, about ⅓ liter to about ⅔ liter capacity, with preference at about ½ liter capacity. In other embodiments the inflatable cushions may have less than about ½ liter capacity. Still in other embodiments the inflatable cushions may have more than about ½ liter capacity. Capacity of the inflatable cushions useful for purposes of the invention may fluctuate and depend upon the general usefulness of a doggy waste bag. Sizes useful for purposes of the present invention include inflatable cushions in which an average human hand can fit comfortably within the inflatable cushion once the inflatable cushion is deflated and/or an inflatable cushion that is roughly the size of a typical doggy waste bag that can be purchased as a standalone item.

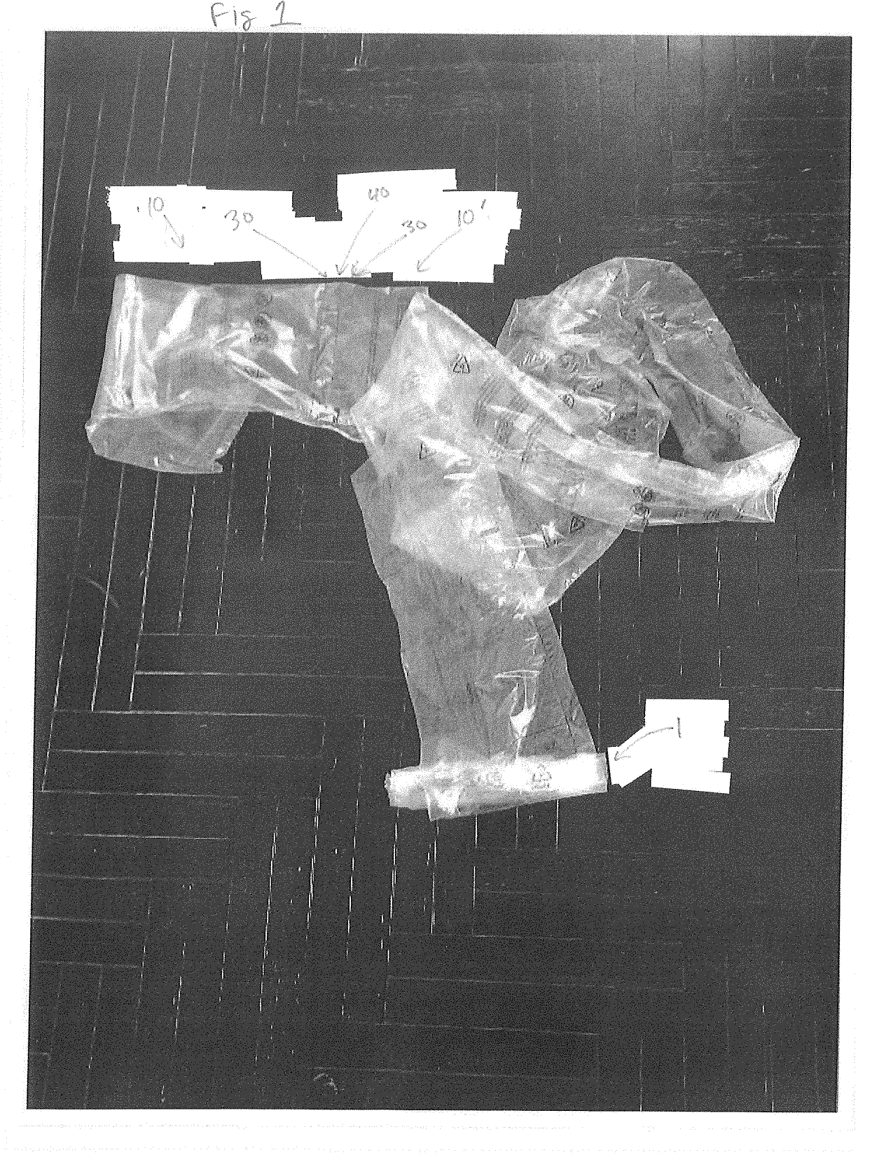

A variety of configurations of films can be utilized in connection with the inflatable cushions of the present invention. For example, referring to FIG. 1, in one embodiment the film may come in a single strip of rolled film (1) and entirely processed onsite prior to packaging, meaning the film is folded or sealed, trapping air within the film onsite. In another embodiment the plastic film may be pre-folded or pre-sealed and then rolled as to eliminate the need for a seam or sealing one or more sides of the inflatable cushion. This reduces the processing needed onsite prior to packaging and reduces the process to sealing and air filling the inflatable cushion. Onsite sealing of the film may occur using heat or other such known devices and mechanisms.

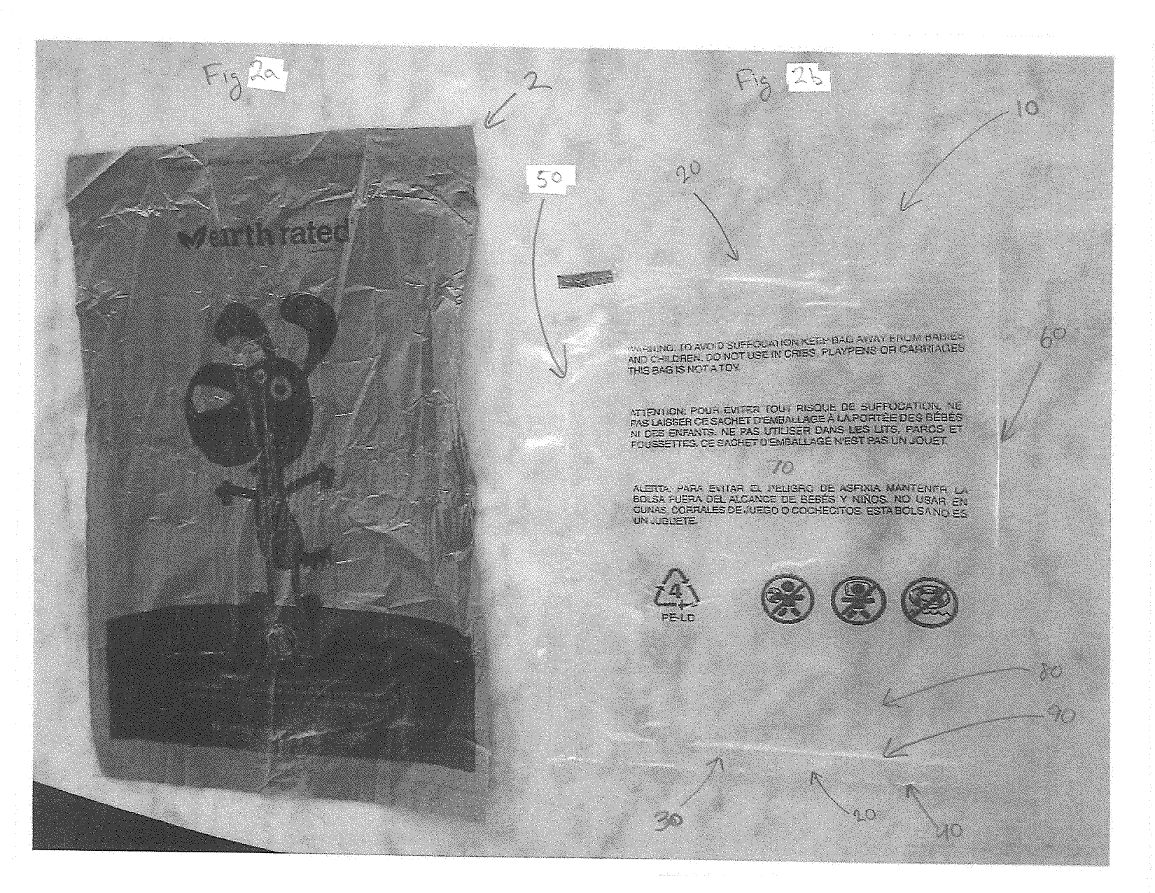

Referring to FIG. 2(a), a conventional doggy waste bag (2) is shown. In such a bag the average size human hand can fit comfortably within. By comparison, a deflated cushion or cell is shown in FIG. 2(b) and is approximately the same size, allowing an average size human hand to fit comfortably within and thus making it useful as a doggy waste bag.

With reference to FIG. 2(b), typically, each inflatable cushion forms a cell (10). Each cell (10) is connected to its neighboring cell by a sealed seam (20). The sealed seam (20) between each cell may be created in a factory or created onsite in the film. In one embodiment, the seam between each cell may be a flattened area (30).

Each cell (10) may be separated from its adjacent cell (10′) and/or from the film. In order to facilitate such separation, lines of weakness may exist between cell (10) and adjacent cell (10′) and/or film, lines of weakness may be utilized between adjacent articles. For example, in one embodiment, the flattened area between each cell may be bisected with perforations (40) or a weakened area so that the inflatable cushions can be separated by hand with modest force. Thus, the user is capable of selecting the appropriate number of cells (10) of a volume to fill the package and provide air cushioning for its contents.

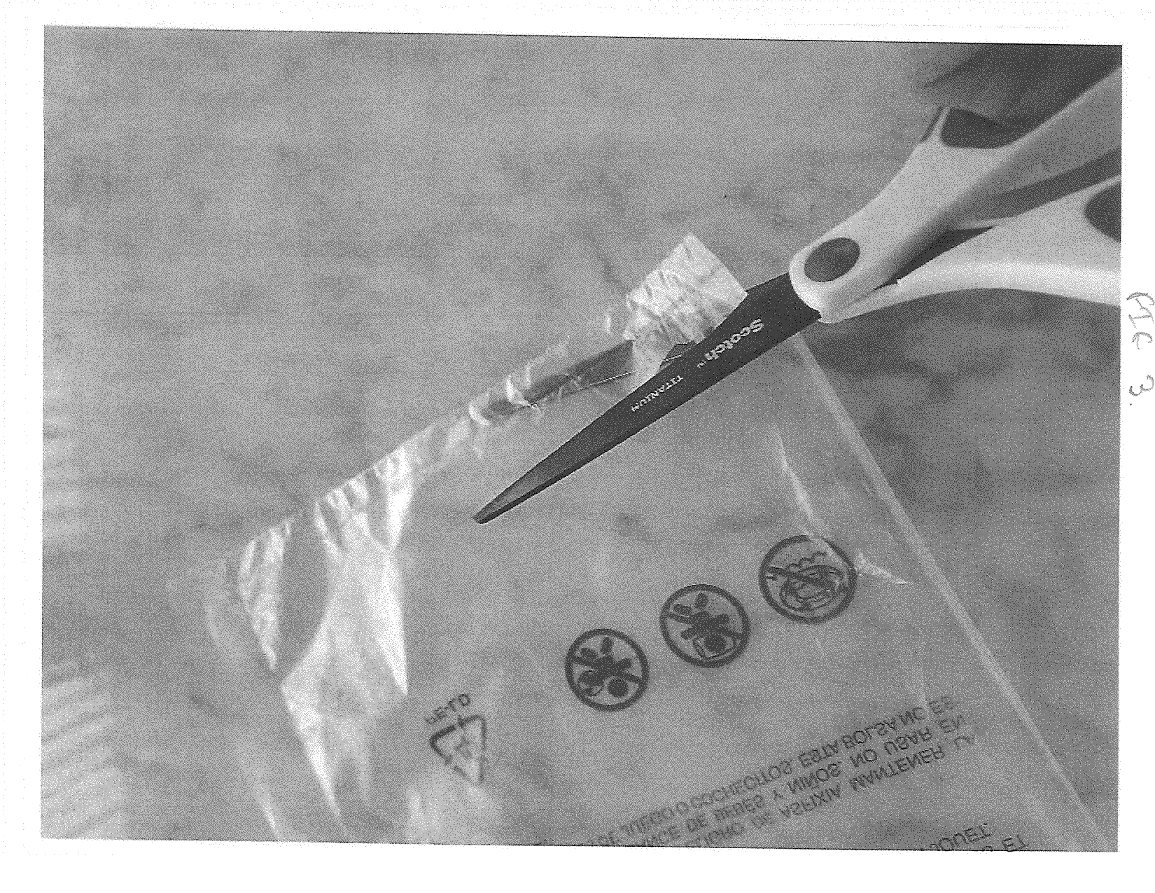

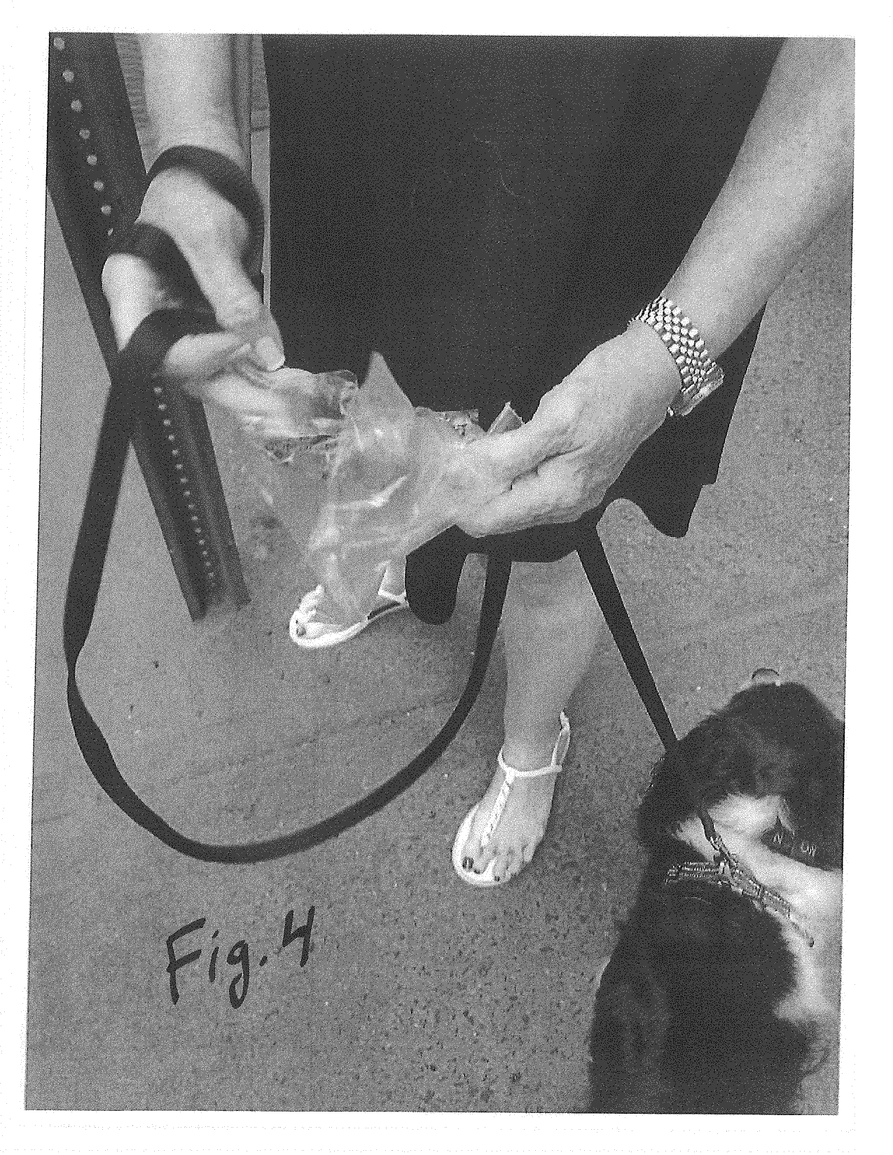

One aspect to the present invention is the method whereby the individual cells (10) may be opened and thereby deflated. If each cell must be opened, perhaps with a pair of scissors or a knife (FIG. 3), the value of the cells for use in accordance with the present invention will be decreased by the amount of labor involved.

To make the deflation of one or more cells easy for the recipient of the cells, it should be made possible to deflate a whole strip of cells by simply grasping opposing sides of cells in each hand and pulling, much like how individual cells are separated from each other based on a weakened or perforated area.

It should be recognized that creating a cell capable of deflation in this manner presents a problem. For example, on the one hand the film or plastic used for the cell must be strong enough to resist the air pressure of the inflation process. It must also be strong enough to resist the pressure of the payload in the shipped package. However, at the same time, the film or plastic must be weak enough in at least a section or seam in order to be separated by pulling on it by hand without any tools or unusual physical strength and allow for deflation.

In order to repurpose or reuse the inflatable cushion as a doggy waste bag in connection with the present invention, the inflatable cushion must first be deflated. Deflating the cushion can be performed by puncturing the film or tearing the film. Known objects can be used to create the puncture or tear in the film. Typically the puncture or tear is made at one end of the film. For example, the puncture or tear is made either close to the seam (20) that connected the film to the adjacent cell. The puncture or tear can also be made at a seam that is created during the inflation process (50) by heat sealing or melting one end of the cell. Often times the heat or melted seal (50) is on the opposite end (60) to that of the portion of the film that has been folded. However, it is recognized that the puncture or tear can be made in other advantageous areas of the inflatable cushion such as in the center of the cell's body (70) in order to produce a deflated cushion for use in connection with the present invention.

Depending upon the location of the tear or puncture, and once the gas/air has been removed from the film, one of the side seams, e.g., (20), may be removed to create a bag. In another embodiment, and depending upon the location of the tear or puncture, the film may be capable of use as a bag without removal of any side edge of the film simply by deflating the cell along the weakened seem or edge.

In one embodiment a sticky or glue like substance can be utilized on the flattened area (30) of the side seems (20) with perforations (40) or a weakened area bisecting the flattened area (30). Such an arrangement would permit each inflatable cushion or cell (10) to maintain separability from the adjacent inflatable cushion or cell (10′) but also retain the ability to deflate relatively easily when separated by pulling on it by hand without any tools or unusual physical strength.

In one embodiment of the present invention a seam or weakened area or perforations are present in the film in order to permit the easy deflation of the cushion. For example, such seam may be present on the body of the film (80). In this particular arrangement the seam is or weakened area is present on one side of the inflatable cushion or air chamber. In yet another example, such a seam or weakened area may be present adjacent to one of the four edges of the film (90), (50) that forms the inflatable cushion.

The location or side of the cell with the seam or weakened area or perforations in the film that permit easy deflation of the cushion can be chosen based upon the dimensions of the cushion and/or type of seam used to create the air chamber in the onsite manufacturing process. For example, if the cushion is rectangular it may be preferential to use the short side of the cushion as the side with the seam or weakened area that can permit easy deflation. Likewise, there may be times where the long side is preferential to utilize as the side with the seam or weakened area that can permit easy deflation.

In one embodiment of the present invention, during manufacturing of the film used to form the inflatable cushion, the perforations or weakened area are along a seam that both allows for separation from the adjacent cell and deflation. In that case, separating the cells would result in deflating them and allowing them to have one open end. The disadvantage of the weakend seem in this location is that there would be a wasted cell per strip when used as intended for packaging. While packages with many cells on a single strip would yield negligible waste, smaller strips with only one or a few cells would result in significant waste. One such option to avoid or minimize additional waste created with this type of perforation or weakened seam is to utilize the weakened seam on alternating seams that separate each inflatable cushion or cell.

In one embodiment of the present invention, when manufacturing the film for the inflatable cushion, a weakened area or perforations can be placed on the film in order to facilitate deflation of the cushion. Such weakened area or perforations can be placed on the body of the inflatable cushion in the inflated area. In another embodiment, a weakened area or perforations can be placed on the body of the inflatable cushion (80) immediately adjacent to one of the edges of the inflatable cushion (90). The inflatable cushions can have one or more weakened area or perforations or other type of area in order to facilitate deflation of the inflatable cushion.

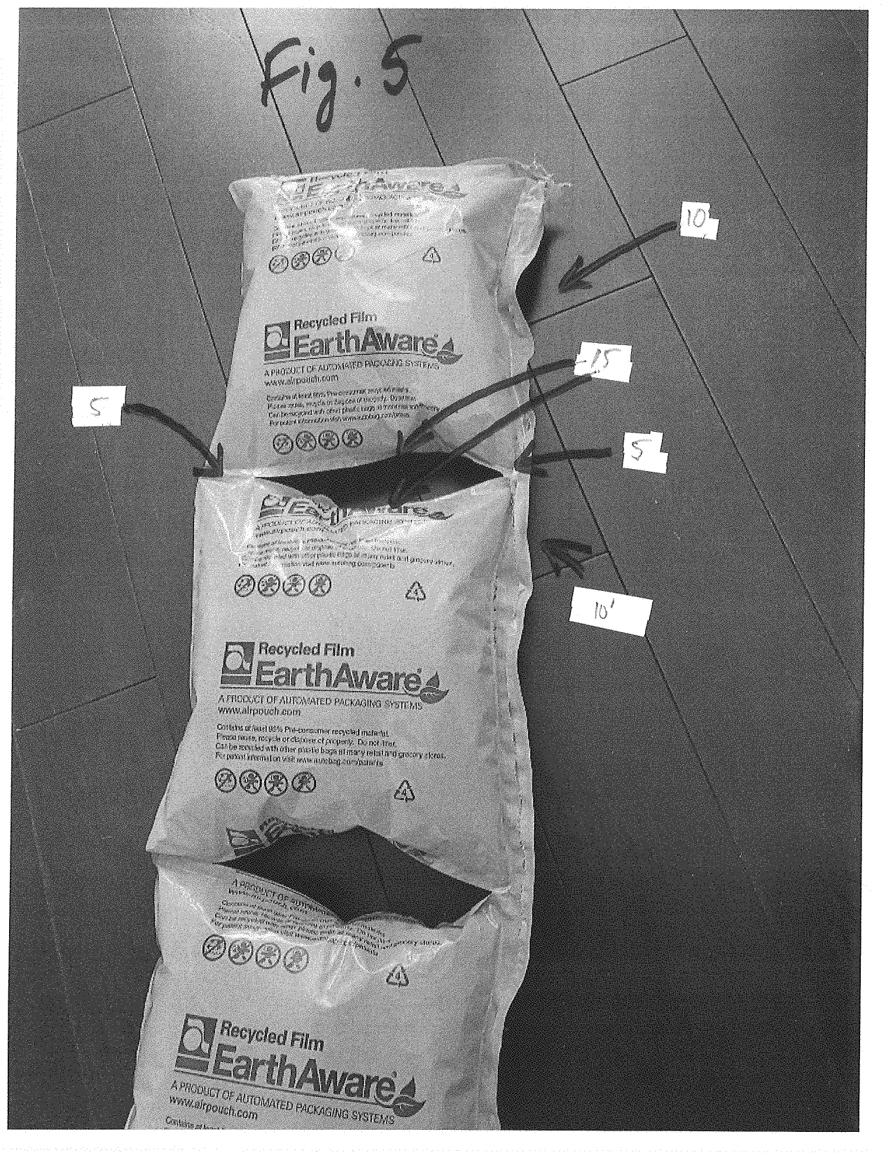

Referring to FIG. 5, in yet another embodiment, the cell (10) may be separated from its adjacent cell (10′) but remain connected at the outer portion of the seam (5). This would permit the cells (10) and (10′) to retain the ability to separate easily. A second breakaway seam (15) can be added between the attached points. The second breakaway seam (15) can utilize the methods and the present invention to achieve a seam that is strong enough to resist the pressure of the payload in a shipped package but at the same time, be weak enough to be separated by pulling on it by hand without any tools or unusual physical strength and allow for deflation.

The weakened area(s) can be aided by printed markings on the film—to distinguish between those weakened areas used for deflating the cushion as compared to those weakened areas used to separate the cushions from an adjacent film.

Because the cell must remain leak free until it is deliberately deflated, actual perforations or extreme weakening of the seams used to seal air inside must be avoided. There are a number of possible ways to create a seam and partially weaken the film or plastic for use in connection with the present invention. In each of the following ways, the film or plastic is not punctured, can withstand the pressures applied by the air or gas used to inflate the cell and the pressures associated with shipping. At the same time the film or plastic may be easily punctured or torn along the perforation or weakened area so that the inflatable cell may be easily deflated and capable for easy disposal or for utilization as a doggy waste bag.

In one embodiment a weakened seam may be created by way of a laser. A laser can be used to melt or deform the plastic or film. It is possible to focus a laser, such as a monochromatic laser, to a very small point at a precise depth. For example, if the plastic sheet or film from which the air cell is made about 50 uM thick, a laser beam could be focused on plastic strip with a depth of field of, e.g., 15 uM, which would have enough energy to melt, pit, or even ablate enough plastic to make separation along the line of laser pits sufficiently separable without destroying the air impermeability. The depth of field can be adjusted by one of skill in the art using known techniques based on the material and thickness used in connection with the inflatable air cell. Laser pulse power and rate may also be adjusted and varied based on known techniques, taking into account the material of the plastic, film or air cell, by one of skill in the art, in order to optimize the weakened area of the film or plastic.

In another embodiment a weakened seam may be created by mechanical weakening. As the plastic or film used in connection with the air cell is produced, it may be passed through a series of rollers or a processing machine. Such rollers or machine may include an additional roller or other type of mechanism designed with small protrusions spaced around the periphery that can be used to indent the film or plastic and weaken it sufficiently, without puncturing. Such roller or machine may also be present during the time of inflation and may indent the plastic or film at that time to sufficiently weaken it for purposes of this invention. The indentation in the film or plastic may be performed to a predetermined depth and adjusted by one of skill in the art using known techniques based on the material and thickness in order to optimize the weakened seam.

In yet another embodiment, directional polymerization may be used to create a weakened seam. During the production of the plastic or film used in connection with the air cell to make the film or plastic tear easier in one direction than in the opposite direction. Air pressure may produce a force perpendicular to the surface of the plastic sheet, while attempted tearing of the sheet will produce a strain along the surface, such a process might eliminate the need for any mechanical weakening.

Glue can also be used to create a weakened seam along one edge of the air cell. For example, glue or a similar sticky substance can be utilized to hold the edge together of an air cell creating a flattened portion between the top and bottom films used to create an air cell. When glue is utilized, the glue would not permanently bond the top and bottom films so that they can no longer be separated. Instead, the glue would either remain tacky or dry to a state that would permit the top and bottom films of the air cell to separate by pulling on them in opposite directions by hand.

Multiple layers of plastic or film may also be utilized to create a weakened seam suitable for use in connection with the present invention. Such multiple layers can be utilized on their own or in combination with any of the above manners to create a weakened seam. Any of the above manners of creating a weakened seam may also be combined in order to facilitate a weakened seam that can be utilized in connection with the present invention.

The methods for creating a weakened seam may be utilized at a factory during manufacturing of the film or plastic used for forming the inflatable cell. In another embodiment, the methods for creating a weakened seam may be utilized onsite while the inflatable cell is being formed, immediately or just prior to packaging an item that is being shipped.

In operation, the present invention may be utilized in the following manner Upon receipt of a shipment, the user removes the air cells from the package. Next, the user separates the air cells from each other. Depending on the location of the weakened area, this may cause the cell to deflate. If not, the user may tear the film or plastic of the inflatable cell along the weakened area or seam to deflate the cell. Once deflated and opened along the weakened area of seam, the user can utilize the deflated cell as a doggy waste bag.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An air cushion or packaging cell comprising,
a. a film or plastic material suitable for creating an air cushion;
b. a folded edge in the film or plastic material that creates a top and a bottom piece of film or plastic material;
c. three sealed edges, two adjacent and 1 opposite the folded edge, whereby the three sealed edges and the folded edge enclose air or gas to form an air cell;
d. one or more seams located on the packaging cell, wherein at least one seam comprises a weakened area capable of withstanding the pressure of gas from within the packaging cell and the pressures involved in protecting an item being shipped.

2. The air cushion or packaging cell of claim 1, wherein one of the sealed edges is the weakened area.

3. The air cushion or packaging cell of claim 1, wherein the weakened area is capable of being torn by hand resulting in deflation of the air cushion or packaging cell.

4. The air cushion or packaging cell of claim 1, wherein the weakened area is located at the edge of one of the three sealed edges.

5. The air cushion or packaging cell of claim 1, wherein the weakened area is located immediately adjacent to the edge of one of the three sealed edges.

6. The air cushion or packaging cell of claim 1, wherein the weakened area on the film or plastic material consists of an area that is melted, pitted, or ablated to a predetermined depth.

7. The air cushion or packaging cell of claim 6, wherein the predetermined depth is about ⅓ the depth of the film or plastic material.

8. The air cushion or packaging cell of claim 7, wherein the weakened area was created by way of focusing a laser to the predetermined depth.

9. The air cushion or packaging cell of claim 8, wherein the laser is a monochromatic laser.

10. The air cushion or packaging cell of claim 1, wherein the weakened area is due to at least one indentation in the film or plastic material to a predetermined depth to sufficiently weaken the film or plastic material.

11. The air cushion or packaging cell of claim 10, wherein the at least one indentation in the film or plastic was created by passing the film or plastic through a series of rollers, wherein at least one roller comprises small protrusions spaced around the periphery and are capable of indenting the film or plastic to sufficiently weaken it without puncturing.

12. The air cushion or packaging cell of claim 1, wherein the weakened area results from directional polymerization during the production of the film or plastic.

13. The air cushion or packaging cell of claim 1, wherein multiple layers of plastic or film comprise the weakened area.

14. The air cushion or packaging cell of claim 2, wherein the sealed edge that forms the weakened area is the sealed by glue.

15. A plurality of air cushion or packaging cells comprising,
a. a film or plastic material suitable for creating an air cushion;
b. a folded edge in the film or plastic material that creates a top and a bottom piece of film or plastic material;
c. a plurality of sealed edges adjacent to the folded edge;
d. a sealed edge opposite the folded edge,
wherein the plurality of sealed edges adjacent to the folded edge are partially bisected longitudinally so that the plurality of air cells remain connected at the portion of the plurality of sealed edges adjacent to the folded edge and adjacent to the sealed edge opposite the folded edge;
wherein the plurality of sealed edges that are adjacent to the folded edge that are partially bisected comprises a weakened area of withstanding the pressure of gas from within the packaging cell and the pressures involved in protecting an item being shipped.
wherein the weakened area is capable of being torn by hand resulting in deflation of the air cushion or packaging cell.

16. The plurality of air cushion or packaging cells of claim 15, wherein the connected portion of the plurality of air cells is bisected with perforations to enable each of the plurality of air cells to become separated.

17. The plurality of air cushion or packaging cells of claim 16, wherein the weakened area is located at the edge of one of the sealed edges that are adjacent to the folded edge.

18. The plurality of air cushion or packaging cells of claim 16, wherein the weakened area is located immediately adjacent to the edge of the edge of one of the sealed edges that are adjacent to the folded edge.

19. The plurality of air cushion or packaging cells of claim 16, wherein the weakened area on the film or plastic material consists of an area that is melted, pitted, or ablated to a predetermined depth.

20. The plurality of air cushion or packaging cells of claim 19, wherein the weakened area results from a laser, mechanical indentations or directional polymerization.
